(19) United States
(12) Patent Application Publication
(10) Pub. No.: US 2005/0077009 A1
(43) Pub. Date: Apr. 14, 2005

(54) Laminate production utilsing improved pressplate

(76) Inventor: David Elwyn Price, Williamstown (AU)

Correspondence Address: MERCHANT & GOULD PC, P.O. BOX 2903, MINNEAPOLIS, MN, 55402-0903, US

(21) Appl. No.: 10/496,443

(22) PCT Filed: Nov. 20, 2002
(86) PCT No.: PCT/AU02/01570

(30) Foreign Application Priority Data
Nov. 20, 2001 (AU) PR 8986

(51) Int. Cl. B31F 1/00; B32B 31/20

(52) U.S. Cl. 156/308.2; 156/219

(57) ABSTRACT

A process for forming a laminated abrasion resistant product includes superposing at least one resin containing layer impregnated with abrasion-resistant particles, with respect to a substrate, and pressing the layer and substrate together in a press containing one or more hot platens for activating the resin or an adhesive between the layer and the substrate. The press includes one or more pressplates that engage a respective surface of the layer with a first textured face thereof to impart a corresponding finish to the engaged surface of the layer. At least one of the pressplates has a second textured face on the other side of the plate from the first textured face, the press further includes a protective layer adjacent the second textured face remote from the layer, for substantially protecting the second textured face against wear, whereby when the first textured face has been utilised for multiple press cycles and requires refinishing or refurbishing, the pressplate may be inverted for further press cycles utilising the second textured face. A press for forming a laminated abrasion resistant product is also disclosed.

### FIELD OF THE INVENTION

This invention relates generally to the enhancement of the lifecycle of textured pressplates used to impart the required gloss and texture to the decorative surface during the manufacture of low pressure directly fused laminates and in particular when the laminates are manufactured with a decorative surface with the inclusion of a hard abrasion resistant particles to provide additional abrasion resistance.

### BACKGROUND ART

Synthetic laminate products are generally formed by adhering in a hot press one or more resin impregnated paper layers to one or both sides of a substrate, or by adhering a previously manufactured multi-layer high pressure laminate to one side of a substrate, or by adhering an impregnated finished foil lacquered with a top coat to one or both sides of a substrate. Depending on the application, the substrate may typically be plywood, hardboard, particle board, oriented strand board (OSB) or fibreboard, although other non wood based substrates may also be used. The laminating, gluing or coating procedure is carried out by any of a variety of equipment, eg. a short cycle press, endless belt press, high pressure press, or other coating or lacquering equipment. Manufactured high pressure laminates (HPL) are usually glued to the substrate.

The most widely used impregnating resin is melamine formaldehyde (MF). Other synthetic resins used, sometimes in combination with each other, include but are not limited to those based on urea, phenolic or polyester resins or acrylic lacquers.

A synthetic laminate may include a unicolour or printed surface or a natural veneer layer for decorative purposes. To achieve protection of the decorative surface over and above the resistance of the cured melamine polymer, it is known and is necessary for many applications including working bench tops, table tops, writing tables and especially flooring laminates, to incorporate hard particles, such as fused alumina, in the laminate structure. One approach is to provide a paper overlay containing hard particles on and/or in the overlay, where the overlay can be of various basis weight, and where the overlay is subsequently impregnated with a saturating resin such as melamine formaldehyde. After impregnation with the synthetic resin, and application as the top layer in the aforementioned laminate, this overlay enables the surface of the laminate to achieve a desired abrasive resistance, for example the various standards explained in EN 13329, usually measured with a device known as a Taber abraser. The basis weight of the overlay paper, the quantity of resin, and in cases where alumina is included in or on the overlay, the quantity, size and shape of the alumina particles, influence the Taber abraser result. Some companies succeed in achieving protection of the decorative surface by applying alumina particles dispersed in a liquid impregnating resin, which may also contain helpful additives such as alpha cellulose, to one or more of the laminate components. Others are known to apply a pre-coating which may contain hard particles, such as fully condensed melamine resin pieces and/or alumina particles, together with alpha cellulose to a laminate component, in most cases directly to the decorative layer, prior to impregnation.

A consequence of the use of hard particles such as fused alumina above the decorative surface is a loss of gloss and eventually loss of definition of the chrome surface and underlying textured surface of the pressplate being used as the tool to transfer a texture to the surface of the decorative laminate. The number of pressings that it is possible to achieve within a required standard is much less than when using the same pressplate and pressing impregnated films that do not contain hard particles such as fused alumina.

The invention involves an appreciation that the reality of having hard particles such as fused alumina in the surface of the impregnated film is that the pressplates have to and can be re-finished and refurbished several times during their lifecycle. The conventional wisdom that pressplates for low pressure direct lamination are textured only on one side is due to the fact that short cycle direct laminating presses without re-cooling are in most if not all cases a single daylight press requiring an upper and lower pressplate, and that with proper care and maintenance the number of pressings is in excess of 100,000. The life of a single pressplate surface may in fact be several hundred thousand pressings, with major repairs usually associated with a foreign object being pressed against the pressplate surface and causing mechanical damage to both the pressplate textured surface and to the metal plate itself. Experience has shown that when pressing against a laminate surface with inclusions of hard particles such as fused alumina, the number of pressings achieved before an unacceptable change in the gloss of the pressplate can be as low as several thousand but mainly in the vicinity of 10,000 to 20,000. New overlay developments are reported to extend a single pressplate textured surface to more than 20,000 pressings.

When pressplates are used with impregnated films containing hard particles such as fused alumina, care must also be taken that the plates are taken out of service and sent back to the manufacturer for re-finishing before damage to the textured surface becomes evident. If mechanical damage to the textured surface does occur the pressplate must be completely refurbished rather than only re-finishing. Re-finishing is defined as dechroming, reworking by polishing and matte-ing the texture to the required gloss level and rechroming. Refurbishing is defined as dechroming, grinding away the textured surface, etching anew the required texture, then further working by polishing and matte-ing the texture to the required gloss level and rechroming.

It is therefore an object of the invention to at least in part extend the useful life of a pressplate.

### SUMMARY OF THE INVENTION

The invention therefore proposes that the object of the invention can be met by texturing and preferably chromeplating both sides of a pressplate intended for use in a press such as a single daylight short cycle press, while protecting the non-operational textured side of the pressplate with a protective layer such as a heat stable and resilient coating or layer, whether attached or not attached to the pressplate, while the pressplate is in use in the press. In this way, the undesirable economic consequences, understood by the present inventor, of using hard particles such as fused alumina in the surface of a decorative laminate, and consequently affecting both the chrome layer and the textured surface of a pressplate, are from an economic perspective substantially reduced due to the fact two cycles can be achieved with one pressplate before the pressplate requires refinishing or refurbishing.

The invention accordingly provides in one aspect, a process for forming a laminated abrasion resistant product including superposing at least one resin containing layer impregnated with abrasion-resistant particles, with respect to a substrate, and pressing the layer and substrate together in a press containing one or more hot platens for activating said resin or an adhesive between said layer and said substrate. The press includes one or more pressplates that engage a respective surface of said layer with a first textured face thereof to impart a corresponding finish to the engaged surface of said layer. At least one of the pressplates has a second textured face on the other side of the plate from the first textured face, the said press further includes a protective layer adjacent the second textured face remote from said layer, for substantially protecting said second textured face against wear, whereby when said first textured face has been utilised for multiple press cycles and requires refinishing or refurbishing, the pressplate may be inverted for further press cycles utilising the second textured face.

In a second aspect, the invention provides a press for forming a laminated abrasion-resistant product, by pressing together a resin containing layer impregnated with abrasion-resistant particles and a substrate. The press includes one or more heatable platens for activating the resin or an adhesive between the layer and the substrate, and one or more pressplates that in operation of the press engage a respective surface of said layer with a first textured face thereof to impart a corresponding finish to the engaged surface of said layer. At least one of the pressplates has a second textured face on the other side of the plate from the first textured face, and said press further includes a protective layer adjacent the second textured face remote from said layer, for substantially protecting said second textured face against wear, whereby when said first textured face has been utilised for multiple press cycles and requires refinishing or refurbishing, the pressplate may be inverted for further press cycles utilising the second textured face.

Preferably, the first and second textured faces formed on respective surface layers of the pressplate, are subsequently chromeplated.

The press may be a single daylight short-cycle press.

In an embodiment, the hot platen is one of a pair of hot platens, the product includes a rear surface, and the press includes a further pressplate to apply a corresponding finish to the rear surface. The further pressplate may have textured faces on the respective sides.

### BRIEF DESCRIPTION OF THE DRAWINGS

The invention will be further described, by way of example only, with reference to the accompanying drawings, in which:

FIG. 1 is a cross-sectional exploded schematic view of a short cycle laminating press assembly according to an embodiment of the invention; and

FIG. 2 is a cross-section of the double-sided textured pressplate of the assembly illustrated in FIG. 1.

### DESCRIPTION OF PREFERRED EMBODIMENTS

The invention is applicable in all laminate applications of the kind generally known as low pressure, shortcycle, laminate pressing processes, that may typically be non re-cooling and utilise a textured pressplate. An application to low pressure direct laminate flooring panels (LPM flooring) will now be described in a non-limiting example.

A laminated abrasion resistant product 10, such as LPM flooring, typically comprises one or more layers on the decorative side 12 with at least one resin containing layer 14, such as a melamine formaldehyde (MF) resin, containing hard abrasion-resistant particles such as fused alumina. The resin containing layer 14 may be a printed decorative paper 16 or may be a clear overlay paper 18. The overlay paper itself may also be impregnated with melamine formaldehyde resin and may contain hard particles, and both impregnated films are subsequently pressed in a short cycle press 20. The overlay paper 18 is present as a carrier of thermosetting MF resin to perform as added wear resistance for the printed or unicolour paper and protection for the contact surfaces of the press 20. An alternative is where the decorative paper 16 does not have any hard particles applied with the impregnating resin and the overlay 18 contains the wear resisting hard particles on and/or in the overlay. It is possible that both the decorative paper 16 and the overlay 18 are treated with or contain hard particles. The hard particles typically comprise particles with a Mohs hardness greater than 6, eg. fused alumina particles.

The resin containing layers 14 are adhered using heat and pressure as an assembly together with a substrate 24, to form a product known as low pressure direct lamination flooring laminate (LPM flooring), in a hot press 20 where the semi-cured resin-containing layers 14 are activated to be fully polymerised and thermoset under pressure and temperature.

The substrate 24 may be, amongst others, a fibreboard (MDF) or particle board (PB) or plywood panel or any other underlay material. It is usual for a balancing paper 28 to be applied to the reverse side of the substrate 24 in the same press cycle.

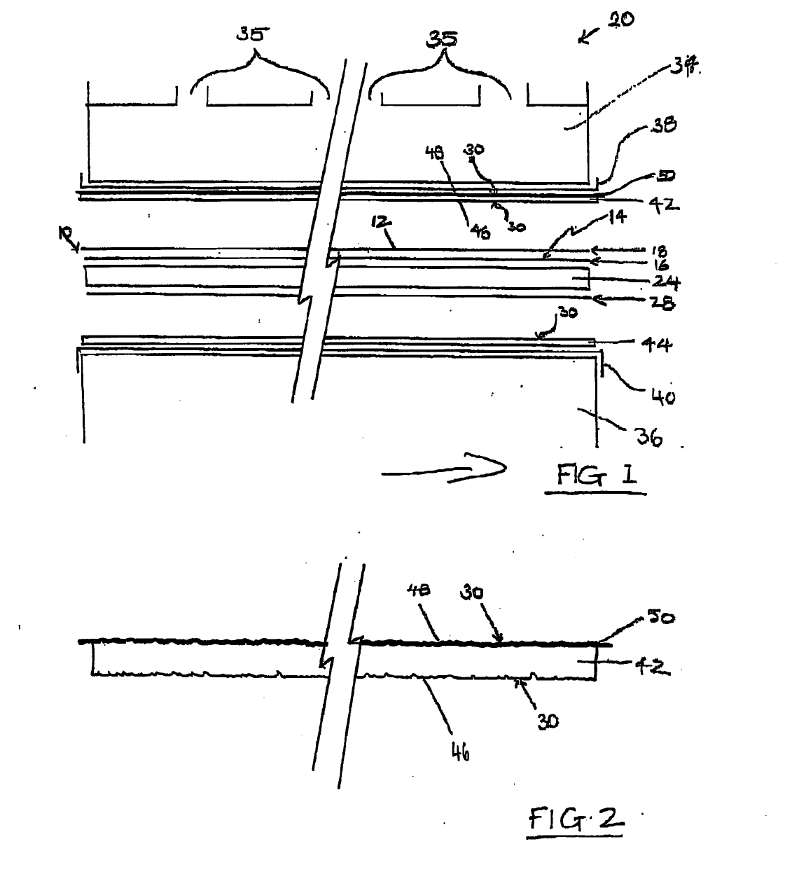

The short-cycle press 20, shown in a basic representation in FIG. 1, includes an upper reciprocable heatable platen 34 activated by multiple rams 35, and a lower stationary heatable platen 36, pressmats 38, 40 and an upper pressplate 42 and lower pressplate 44. Pressmats 38, 40 are located between the platens 34, 36 and the pressplates 42, 44. The pressplates 42, 44 have a chrome plate surface 30. The textured faces of pressplates 42, 44 are used to impart a corresponding finish such as a desired gloss level and texture to the respective engaged surfaces of the laminate. In a short cycle pressing process pressure and therefore the pressplates are typically applied for a period of 5 seconds to 1 minute, eg. 10-20 seconds and the temperature is typically of the order of 180° C.

The hard particles necessary to obtain standardised Taber abrasion levels for the surface of the laminate have a deleterious effect on the chrome plate surface 30 of the pressplates 42, 44, eventually if used for too many pressings also effecting the textured surface itself. If the pressplates 42, 44 are taken out of service to have the chrome plate surface 30 removed and the gloss level adjusted back to the required level, the dechroming and repolishing and matte-ing tends to have a rounding and wear effect on the texture so that eventually the only possible reworking is a complete refurbishing of the pressplate surface.

The present invention, contrary to the conventional assumption that pressplates used in low pressure direct pressing of an impregnated film to the surface of a substrate have the texture etched only on one side of the plate, involves etching a texture and applying chromeplating to both sides of the pressplate, as illustrated in FIG. 2. The press 20 depicted in FIG. 1 shows lower pressplate 44 as a conventional one-sided plate, and upper pressplate 42 as a two-sided plate. Pressplate 42 has at any given time in the process, an operational side 46 and non-operational side 48. Protection in the press 20 of the textured and chromeplated but non-operational side 48 of the pressplate 42—also described as the side of the pressplate 42 in direct contact to the pressmat 38, or if no mat is used in direct contact with the hot platen 34—is provided by a heat stable and resilient protective layer 50 while the pressplate 42 is in use in the press 20. The protective layer 50 can be applied directly to one side of the pressplate 42 or may attached to the pressplate 42, or be a non-attached protective layer 50, but in any case is placed between the pressplate 42 and the compensating pressmat 38 or hot platen 34.

When the first used side of the pressplate 42 requires re-finishing or refurbishing due to an unacceptable change of gloss or minor damage to the textured surface, the pressplate 42 is removed from the press 20 and the so-called reverse or backside is prepared by removal of the protective layer 50 and or cleaning of any extraneous matter. Cleaning may be by any means that does not damage the chrome layer 30 or the textured surface. One example of such a cleaning method is application of dry ice to the extraneous matter and subsequent removal of the extraneous matter. On inversion of the pressplate, the original operational side 46 should then be protected with a protective layer 50 to avoid further damage to the textured surface by contact with the pressmat 38. The pressplate 42 with the unused second or reverse/backside textured and chromed surface 48 can now be returned to service in the short cycle press 20 in an inverted condition.

Only when both surfaces have been found to have changes to the gloss and or texture that require re-finishing or refurbishing, must the pressplate 42 be shipped back to the manufacturer for reworking.

1. A process for forming a laminated abrasion resistant product including:
superposing at least one resin containing layer impregnated with abrasion-resistant particles, with respect to a substrate; and
pressing the layer and substrate together in a press containing one or more hot platens for activating said resin or an adhesive between said layer and said substrate;
wherein the press includes one or more pressplates that engage a respective surface of said layer with a first textured face thereof to impart a corresponding finish to the engaged surface of said layer;
and wherein at least one of said pressplates has a second textured face on the other side of the plate from the first textured face, and said press further includes a protective layer adjacent the second textured face remote from said layer, for substantially protecting said second textured face against wear, whereby when said first textured face has been utilised for multiple press cycles and requires refinishing or refurbishing, the pressplate may be inverted for further press cycles utilising the second textured face.

2. A process according to claim 1 wherein said first and second textured faces are formed on respective surface layers of said pressplate.

3. A process according to claim 2 wherein said surface layers are chrome-plated.

4. A process according to claim 1, where said press is a single daylight short-cycle press.

5. A process according to claim 1, wherein said hot platen is one of a pair of hot platens, said product includes a rear surface, and said press includes a further pressplate to apply a corresponding finish to said rear surface.

6. A process according to claim 5 wherein said further pressplate has textured faces on its respective sides.

7. A process according to claim 1 wherein said particles comprise particles with a Mohs hardness greater than 6.

8. A process according to claim 7 wherein said particles are fused alumina particles.

9. A press for forming a laminated abrasion-resistant product, by pressing together a resin containing layer impregnated with abrasion-resistant particles and a substrate, including:
one or more heatable platens for activating said resin or an adhesive between said layer and said substrate; and
one or more pressplates that in operation of the press engage a respective surface of said layer with a first textured face thereof to impart a corresponding finish to the engaged surface of said layer;
wherein at least one of said pressplates has a second textured face on the other sides of the plate from the first textured face, and said press further includes a protective layer adjacent the second textured face remote from said layer, for substantially protecting said second textured face against wear, whereby when said first textured face has been utilised for multiple press cycles and requires refinishing or refurbishing, the pressplate may be inverted for further press cycles utilising the second textured face.

10. A press according to claim 9 wherein said first and second textured faces are formed on respective surface layers of said pressplate.

11. A press according to claim 10 wherein said surface layers are chrome-plated.

12. A press according to claim 9, where said press is a single daylight short-cycle press.

13. A press according to claim 9, wherein said hot platen is one of a pair of hot platens, said product includes a rear surface, and said press includes a further pressplate to apply a corresponding finish to said rear surface

14. A press according to claim 13 wherein said further pressplate has textured faces on its respective sides.
